(19) United States
(12) Patent Application Publication
(10) Pub. No.: US 2003/0069133 A1
(43) Pub. Date: Apr. 10, 2003

(54) Formed product made from refuse derived fuel and method for production thereof

(76) Inventors: Yasuyuki Yamaguchi, Okayama (JP); Takuya Tsubota, Okayama (JP); Utaka Yamauchi, Okayama (JP); Ryoichi Nagata, Okayama (JP)

Correspondence Address: YOUNG & THOMPSON, 745 SOUTH 23RD STREET 2ND FLOOR, ARLINGTON, VA, 22202

(21) Appl. No.: 10/069,594

(22) PCT Filed: Jul. 3, 2001
(86) PCT No.: PCT/JP01/05747

(30) Foreign Application Priority Data
Jul. 6, 2000 (JP) 2000-204851

(51) Int. Cl. B01J 20/02

(52) U.S. Cl. 502/406

(57) ABSTRACT

This application provides an invention of a molded product comprising a carbonaceous material having a carbon content of 30 to 70 mass % obtained by dry distillation of solidified refuse fuels and a binder. Since the molded product can be utilized as an environment cleaning material such as for foul water cleaning as it is or after processing, it can provide a stage of effectively utilizing refuses and promote consumption thereof.

### TECHNICAL FIELD

This invention concerns a molded product prepared from a so-called RDF (Refuse Derived Fuel) which is a solid fuel obtained by pulverizing, drying and molding refuses, as well as a manufacturing method thereof. Further, it particularly concerns an environmental cleaning material using the molded product.

### BACKGROUND ART

In recent years, refuse disposing and utilizing technique of selecting and collecting combustible refuses from industrial wastes, so-called refuses and then pulverizing, drying and molding the refuses into solid fuels have been developed variously. Such technique can include, for example, Japanese Patent No. 2865541 and 2981399, as well as Japanese Patent Laid-Open No. 86569/1996.

That is, after pulverizing refuses such as municipal refuses, domestic refuses, industrial wastes and general wastes, they are dried for reducing the water content in the refuses and, by way of a selecting operation of removing metals, glass and potteries, molded to a predetermined shape, for example, a crayon shape to obtain solid fuels. Such solidified refuse fuels are referred to as RDF.

The solidified refuse fuels have been utilized as heat sources for cooling and heating use in various facilities and as fuels for electric power generation. However, for utilization, they require installation investment such as for new construction of facilities suitable to solidified refuse fuels and modification of existent facilities. On the other hand, the amount of refuses formed daily has increased more and more and it has been demanded to increase the solidified refuse fuels correspondingly with a view point of environmental preservation.

However, no sufficient facilities have yet been provided at present for the utilization of the solidified refuse fuels and mere increase in the production of the solidified refuse fuels has no usefulness.

In view of the above, this invention intends to newly develop a stage for effectively utilizing solidified refuse fuels and promote consumption thereof. Particularly, it proposes a utilization method thereof in view of environmental preservation.

The present inventors, as a result of searching a method of utilizing solidified refuse fuels in the form that they can contribute to environmental preservation, have reached an idea of using them as cleaning materials for polluted environment. Particularly, water resources such as ponds, lakes, rivers and seas have been contaminated year by year by intrusion of industrial waste water, living waste water and the like, which brings about serious social problems, so that new development of foul water disposal technique has keenly been demanded and it has been recognized that utilization of them as the material for cleaning foul water is useful.

Further, since carbonaceous materials such as char are highly biophilic and form biofilms on the surface thereof, they have a foul water cleaning function and have now been started to be used for cleaning of waste water from golf links or municipal sewage (referred to each of Japanese Patent Laid-Open No. 56754/1977 and Japanese Patent Laid-Open No. 295578/1996). In view of the background described above, the present inventors have made an earnest study on the method capable of utilizing solidified refuse fuels resulted from environmental preservation type refuse disposal further to the cleaning of environment and have accomplished the invention.

### DISCLOSURE OF THE INVENTION

That is, this invention provides a molded product comprising a carbonaceous material having a carbon content of 30 to 70 mass % obtained by dry distillation of solidified refuse fuels and a binder.

The molded product preferably contains from 5 to 90 mass % of the binder and the binder used in this case is further preferably, at least one material selected from the group consisting of cement, gypsum, clay and soil hardening agent.

Further, in this invention, any of the molded products described above is preferably further mixed with at least one material selected from the group consisting of iron and iron compounds in which the iron compound to be mixed is, more preferably, at least one material selected from the group consisting of iron oxides, iron hydroxides, iron ores and iron sands.

Any of the molded products described above preferably has a bulk specific gravity of 1.2 to 2.0.

Further, any of the molded products described above preferably has a particle diameter of 0.5 to 50.0 mm.

Among all, this invention also provides an environment cleaning material using any of the molded products described above as the embodiments of this invention.

Further, this invention also includes a method of manufacturing a molded product comprising dry distilling solidified refuse fuels to obtain a carbonaceous material having 30 to 70 mass % of carbon content, mixing a binder with the carbonaceous material, molding and then drying the same. In the manufacturing method, a method of mixing at least one material selected from the group consisting of iron and iron compounds is preferred, and a manufacturing method of using the carbonaceous material after washing with water is more preferred.

### BRIEF EXPLANATION OF THE DRAWINGS

FIG. 1 is a view showing an example of a facility for manufacturing a carbonaceous material used in this invention.

FIG. 2 is a view showing another example of a facility for manufacturing a carbonaceous material used in this invention.

FIG. 3 is a view illustrating steps of manufacturing a molded product and an environment cleaning material from carbonaceous material

### BEST MODE FOR CARRYING OUT THE INVENTION

This invention is to be explained specifically.

It has been found according to this invention that the solidified refuse fuels can function as a cleaning material for foul water by using a carbonaceous material and further providing an appropriate shape or controlling the specific gravity. Accordingly, the molded product and the environment cleaning material using the same according to this invention are started from so-called RDF, that is, solidified refuse fuels processed into a predetermined shape by way of pulverization, drying and molding of refuses.

That is, this invention provides a molded product comprising a carbonaceous material having 30 to 70 mass % of carbon content obtained by dry distillation of the solidified refuse fuels and the binder or an environmental cleaning material using the same.

For the carbonaceous material constituting the molded product in this invention, those having a carbon content of 30 to 70 mass % are used. That is, in a case of using this molded product as the environment cleaning material, the cleaning function can be ensured sufficiently when the carbon content of the carbonaceous material is 30 mass % or more. On the other hand, when the carbon content is 70 mass % or less, it forms a carbonaceous material with less volatile components, so that there is no worry of causing water pollution by leaching of oil components in water upon use of the molded product as the environment cleaning material. The carbon content of the molded product of this invention is preferably 30 to 60 mass % and, further preferably, 40 to 60 mass %. Accordingly, when the solidified refuse fuels are dry distilled, dry distilling conditions are selected such that a carbonaceous material having a carbon content of 30 to 70 mass % is obtained.

Usually, carbonaceous materials obtained by such dry distillation are often in the form of a powder having a particle diameter of about 0.05 to 5.0 mm. There is no particular restriction on the particle diameter of the carbonaceous material in this invention. However, depending on the shape, they can naturally be used by being formed into usual particle diameters by pulverization or the like.

Now, when solidified refuse fuels comprising refuses such as municipal refuses, domestic refuses, industrial wastes and general wastes are dry distilled, a carbonaceous powder having typical ingredient composition, for example, shown in Table 1 can be obtained. Since the carbonaceous material is highly biophilic and forms biofilms on the surface, it is effective to cleaning of foul water. However, when it is used in the form of the powder as it is, it does not settle in a foul water area but is carried away, making it difficult to play a role thereof. In view of the above, it is necessary to provide the carbonaceous material with a certain size and a shape by mixing a binder in order that the material stays in the foul water area and forms biofilms on the surface to contribute to cleaning. Further, it is also necessary to provide a desired specific gravity. Accordingly, the molded product of this invention contains a binder.

The content of the binder in the molded product of this invention is preferably 5 to 90 mass %. This is because a shape with a sufficient strength can be maintained after mixing the binder with the carbonaceous material and molding them, when the content of the binder is 5 mass % or more. On the other hand, the cleaning function can be developed easily when the binder content is 90 mass % or less and, accordingly, the content of the carbon material is at least 10 mass % or more. A more preferred binder content is 10 to 30 mass %.

The binder has a function of joining the carbonaceous materials to each other and those of a type that can attain joining by filling gaps between each of the materials are preferred. That is, when the binder of this type is used, aggregates of the carbonaceous material joined by way of the binder, that is, the molded product becomes porous and the porosity is increased, so that the exposed area is increased. Accordingly, when such a molded product is used as the environment cleaning material, since the exposed area of the carbonaceous material in contact with foul water also increases, high cleaning performance can be obtained. As the binder of this type, at least one material selected from the group consisting of cement, gypsum, clay and soil hardening agent is preferred. Among all, cement is recommended since it exhibits a strength at the content of about 10 mass % and can provide necessary and sufficient strength at about 30 mass %. Preferred soil curing agent can include, for example, a mixture of lightly sintered magnesium and fused magnesium phosphate. Since the soil hardening agent is weakly alkaline and also has a an effect as the fused magnesium phosphate, it is advantageous for the growing of plants.

On the contrary, those of a type that function to surround the carbonaceous material like a film are not suitable when acting as the binder. That is, it is necessary that the carbonaceous material is exposed on the surface as the molded product and the environment cleaning material. When the carbonaceous material is covered with the binder, the exposed area of the carbonaceous material is decreased and it no more develops the inherent function. The binder of this type includes water glass or resin, and the use of them should preferably be avoided.

Further, in this invention, the molded product described above or the environment cleaning material using the same as the starting material is preferably mixed with at least one material selected from the group consisting of iron and iron compounds (hereinafter sometimes referred to as an iron source). In this case, the iron compound to be mixed is further preferably at least one material selected from the group consisting of iron oxides, iron hydroxides, iron ores and iron sands.

The iron source is used suitably for the control of specific gravity or as an iron ion source in the molded product molded by way of the binder and the environment cleaning material. That is, the molded product and the environment cleaning material is used mainly being scattered in a polluted area. When the polluted area is present in sea or river, it suffers from the effect of ebb tide and high tide at the seashore and water stream in the river. In such a case, the scattered molded product or the environment cleaning material is localized and, as a result, the function thereof may sometimes not prevail over the entire pollution area. It is preferred to control the specific gravity such that the molded product or the environment cleaning material does not localize after scattering. For the control of the specific gravity, it is important that the molded product and the environment cleaning material has a specific gravity in accordance with the working circumstance. For example, in a case of scattering on the seashore, when the specific gravity is conditioned substantially identical with that of sands on the seashore, localization can be prevented since they show the identical behavior with that of sands. Accordingly, it is extremely advantageous to vary the mixing amount of the iron source to control the specific gravity in accordance with the scattering circumstance of the molded product or the environment cleaning material. By the control of the specific gravity, the function of the molded product or the environment cleaning material prevails generally over a desired range. In view of the application use described above, the bulk specific gravity of the molded product or the environment cleaning material using the same of this invention is preferably 1.2 to 2.0, more preferably, 1.4 to 1.7 irrespective of the use of the iron source. Since the molded product of this invention or the environment cleaning material using the same is advantageous for the cleaning of environment in a case where it is porous, the specific gravity is defined by the bulk specific gravity.

The iron source in the molded product or the environment cleaning material has a role as a specific gravity controller for approximating the specific gravity to that of precipitates or deposits in the sea area (water area) to be cleaned. Then, with respect to the content of the iron source, it is desirable to add the same so as to contain 10 mass % or more of the carbonaceous material from the standpoint of securing the cleaning action. Accordingly, it is preferred for such a form of use that contains less than 70 mass % of the carbonaceous material upon mixing the material and the iron source. Further, since the iron source creates an environment suitable to growing of algae and inhabitation of micro livings by the effect of iron ions leached from the source, it develops an excellent function for the environment cleaning in cooperation with the effect of the carbonaceous material. Further, as the iron source, collected dusts in iron making factories or steel making factories, pulverized powder of iron ores or iron powder and iron sand used for powder metallurgy can be used. Since any of them has a higher specific gravity, it is suitable to the specific gravity control material. Further, since this is inexpensive, it is a material suitable to combination with an inexpensive carbonaceous material from the refuse as the starting material.

Further, since iron scraps have already been used actually as fish reefs and the iron content is an element abundant in the natural world, the iron source has no worry of worsening the environment even with it is incorporated in the molded product and the environment cleaning material.

Thus, since the molded product molded by mixing the binder and, optionally, the iron source to the carbonaceous material and the environment cleaning material have a necessary mass, particularly, a specific gravity to settle upon charge into the foul water area, they can be retained in the foul water area. Further, since the molded product and the environment cleaning material have a structure in which the carbonaceous material and the iron source are deposited on the periphery of the binder component, biofilms are formed to the carbonaceous material and, as a result, micro bacterial cleaning is conducted therein. Further, an effect similar with that of the activated carbon that directly adsorbs polluting ingredients to the carbonaceous material can also be expected.

Further in this invention, the molded product and the environment cleaning material in any of the embodiments described above have no particular restriction in view of the shape and may take appropriate shape in accordance with the working circumstance. However, in view of cleaning in the water quality environment described above, it is preferably in a granular form with a particle diameter of 0.5 to 50.0 mm. This is because there is less worry of water pollution and flushing loss due to water stream when the particle diameter is 0.5 mm or more. On the other hand, the specific surface area is not decreased and the cleaning function is not deteriorated when the particle diameter is 50.0 mm or less. More preferably, it is within a range from 1.0 to 30.0 mm. It is advantageous for avoiding water pollution and flushing loss with water stream, to select the particle diameter within the range described above, to control the particle diameter within the predetermined range to 90% or more based on the entire granular material, or to sieve the resultant granular material and exclude those out of the range, during the molding by granulation.

As exemplified in Table 1, for the ingredients of the carbonaceous material obtained by dry distillation of solidified refuse fuels, since chlorine derived from refuses is inevitably contained in the carbonaceous material obtained from general refuses, the molded product manufactured from the carbonaceous material and the environment cleaning material is optimally used for pollution of sea. However, it is also possible to apply the molded product and the environment cleaning material to pollution of fresh water when dechlorination to be described later is applied. Further, it provides a great advantage in view of application that the molded product and the environment cleaning material can be applied only by scattering them into necessary sea area or water area.

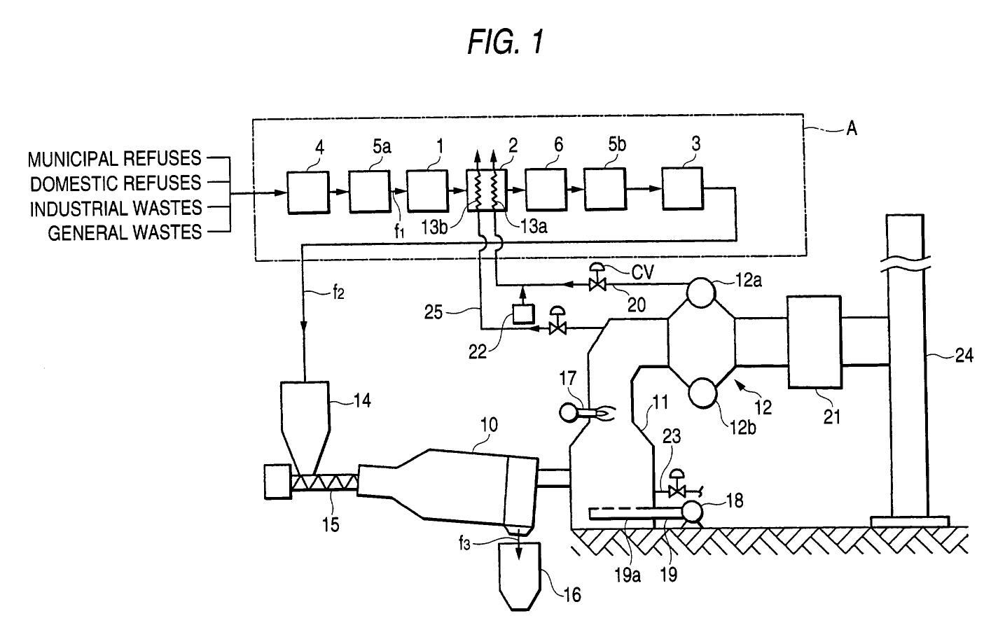

Furthermore, since the molded product and the environment cleaning material according to this invention have an adsorbing effect due to carbon to pollutants, as well as contain C, Ca and K as plant nutrient elements, they can be used also as a soil improver as shown in FIG. 1. That is, when the molded product and the environment cleaning material are scattered on soils, since bacteria grow in the pores of the carbonaceous material, the soil can be activated. In the case of using them as the soil improver as described above, it is advantageous to use the molded product and the environment cleaning material at a diameter of 30.0 mm or less.

Further, this patent application also provides an invention concerning a method of manufacturing a molded product which comprises dry distilling solidified refuse fuels to obtain a carbonaceous material having a carbon content of 30 to 70 mass %, molding the carbonaceous material in admixture with a binder and then drying them.

In the manufacturing method, a method of further mixing at least one material selected from the group consisting of iron and iron compounds (hereinafter sometimes referred to as an iron source) upon mixing the binder is preferred and a manufacturing method of using the carbonaceous material after washing with water is further preferred.

A method of manufacturing a molded product according to this invention is to be explained specifically with referring to drawings.

At first, FIG. 1 illustrates an example of a production facility for manufacturing the carbonaceous material from refuses by way of solidified refuse fuels. In FIG. 1, production of solidified refuse fuels is shown by a step chart A and a succeeding dry distillation processing of solidified refuse fuels is shown by a schematic view.

In FIG. 1, are shown pulverizers 1 and 6, a drier 2, a molding machine 3, a separator 4 for foreign matters from refuses, magnetic selectors 5a and 5b, a dry distillation furnace 10, a dry distillation gas combustion device 11, a boiler 12, water pipe bundles 12a and 12b, heat exchangers 13a and 13b, a solidified refuse fuel storage hopper 14, a constant amount feeding device 15 of solidified refuse fuels such as a screw feeder, a storage hopper 16 for carbonaceous material after dry distillation, an after burner 17, a combustion air blower 18, a combustion air feed pipeline 19, a combustion air feed header 19a, a steam feed pipeline 20 to the drier 2, a combustion gas quenching device 21, a package boiler 22, a pure oxygen/oxygen enriched air feed pipeline 23, a stack 24, a combustion gas feed pipeline 25 for the drier 2, a flow rate control valve CV, refuse transportation direction f₁, solidified refuse fuel transportation direction f₂ and carbonaceous material discharging direction f₃.

A heating furnace such as an internal combustion turning type kiln is preferably used for the dry distillation furnace 10 but there is no particular restriction on the type of the dry distillation furnace 10. Further, for the heat exchanging means 13a between steams generated in the boiler 12 and refuses in the refuse drier 2, an indirect heat exchanger between the steams and the refuses is disposed preferably disposed in view of prevention of oxidation of the refuses but there is no particular restriction on the means so long as it can prevent oxidation of the refuses.

Now, in the production facility shown in FIG. 1, metal, glass and pottery wastes are removed by the foreign matter separator 4 and the magnetic selector 5a from general refuses such as municipal refuses and domestic refuses, industrial wastes, general wastes and refuses from shredder dusts obtained by pulverization of domestic electric products and automobile parts. Subsequently, obtained refuses mainly comprising combustible matters are pulverized by the pulverizer 1 and dried by the steams from the boiler 12 as a heat source.

Then, after pulverizing the refuses again after drying, they are optionally removed with metals by the magnetic selector 5b and molded in the molding machine 3 to produce solidified refuse fuels. The solidified refuse fuels are supplied by way of the storage hopper 14 and the constant amount feed device 15 to the distillation furnace 10.

In the dry distillation furnace 10, the solidified refuse fuels are dry distilled. In this case, when dry distillation is applied while maintaining the oxygen concentration in the furnace at 1 vol % or less, a carbonaceous material having a carbon content of 30 to 70 mass % according to this invention can be obtained. Since volatile ingredients in the solidified refuse fuels are released by the dry distillation treatment, the carbonaceous material becomes porous. Further, for restricting the concentration of dioxine generated from the carbonaceous material to a predetermined value or less, the process is conducted preferably, for example, by controlling the oxygen concentration in the furnace to 1 vol % or less by the adjustment of the amount of air fed to the furnace and controlling the dry distillation temperature to 600° C. or higher, preferably, 800° C. or higher.

The carbonaceous material produced by dry distillation in the dry distillation furnace 10 is discharged from the dry distillation furnace 10 and stored in the storage hopper 16.

On the other hand, the dry distillation gas generated upon dry distillation is burnt completely in the combustion device 11. It is preferred to blow a combustion gas at a high temperature from the burner 17 in view of safety. Then, the combustion gas at a high temperature of 1000° C. or higher generated in the combustion device 11 is recovered with heat in the boiler 12 in the form of steams, quenched by the combustion gas quenching device 21 and then exhausted through the stack 24.

In this case, formation of dioxins can be prevented reliably by controlling the temperature of the combustion gas at the exit of the boiler 12 to 600° C. or higher, preferably, 800° C. or higher, the staying time of the combustion gas in a temperature region of 600° C. or higher, preferably, 800° C. or higher in the combustion device 11 and the boiler 12 to two sec or more and quenching the combustion gas by the combustion gas quenching device 21.

Steams generated in the boiler 12 are fed by way of the steam feed pipeline 20 to the solidified refuse fuel production facility and used as a heat source for drying the refuses through the heat exchanging means 13a.

In a case where the solidified refuse fuel production facility is operated not continuously but batchwise (intermittent system), steams can not be obtained at the start of the operation. Accordingly, steams from the package boiler 22 are used in this case for drying the refuses upon start of the operation. The package boiler 22 can generate steams in a short time due to kerosene combustion or heavy oil combustion. Then, drying of the refuses is started by the steams from the package boiler 22. Subsequently, when stationary generation of steams from the boiler 11 by generation of the dry distillation gas in the dry distillation furnace 10 is confirmed, the package boiler 22 is stopped.

Further, as shown in FIG. 1, the refuses may be dried also by feeding the combustion gas generated from the high temperature combustion of the dry distillation gas through the combustion gas feed pipeline 30 to the drier 2, and conducting heat exchange relative to the refuses by way of the heat exchanging means 13b.

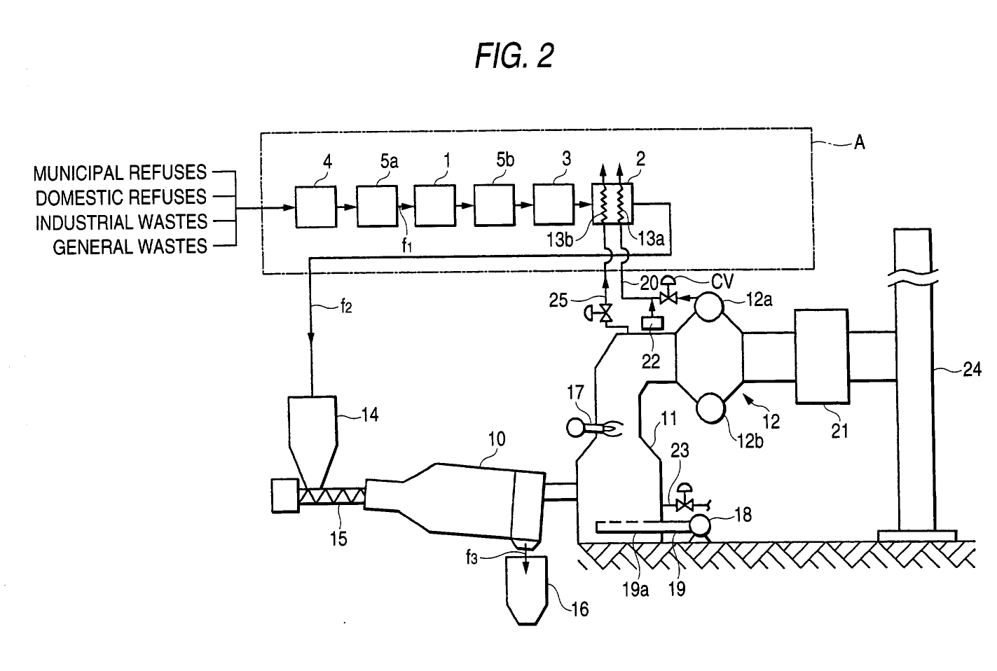

Further, as shown in FIG. 2, it is also possible to produce solidified refuse fuels by pulverizing the refuses by the pulverizer 1, molding them in the molding machine 3 and then drying them in the drier 2.

In the production facility of FIG. 1 or FIG. 2 described above, the pure oxygen/oxygen enriched air feed pipeline 23 is preferably disposed to the dry distillation gas combustion gas 11 for blowing pure oxygen and/or oxygen enriched air and pure oxygen and/or oxygen enriched air at the oxygen concentration exceeding 21 vol % is mixed with the combustion air. This is because blowing of pure oxygen and/or oxygen enriched air to the dry distillation gas combustion device enables to attain combustion at a further higher temperature in the dry distillation gas combustion device 11 to suppress formation of dioxins more easily.

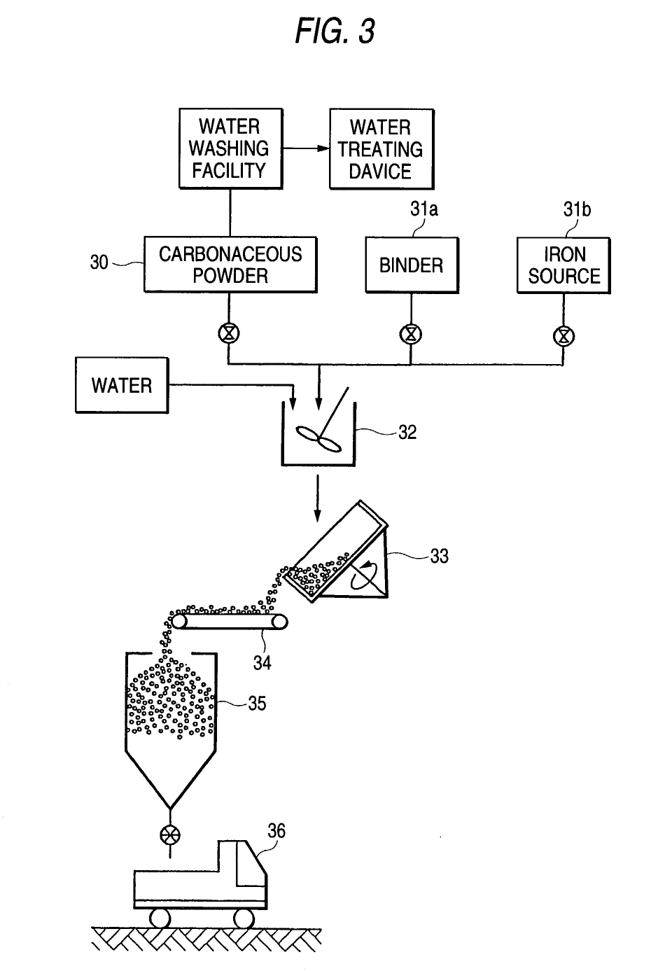

The carbonaceous material produced in accordance with the foregoing procedures is optionally applied with a water washing treatment and then transported to the succeeding step. The transported carbon materials is mixed with the binder and, if necessary, further with the iron source. The molded product or the environment purifying material using the same according to this invention preferably has a specific gravity conforming the working circumstance and the iron source is used suitably to the control of the specific gravity. That is, as shown in FIG. 3, a carbonaceous material 30, a binder (for example, cement) 31a and, if necessary, an iron source (for example, iron sand) 31b are delivered each in a predetermined amount to a stirring vessel 32. In the stirring vessel 32, the content is further mixed with addition of water and the mixture is fed to a molding machine (for example, pelletizer) 33. They are molded into a predetermined diameter in the molding machine 33, dried to solidness by heating on the conveyor 34 and then stored in a hopper 35. Then, they are delivered, for example, on a conveyor truck 36 and then shipped.

In the example shown in FIG. 3, a disk type pelletizer is illustrated as an example of the molding machine 33 but a vibrational granulator or like other usual pelletizer or molding machine may also be used.

Further, in a case where chlorine derived from refuses is not favorable as the molded product and the environment cleaning material, chlorine may be removed further from the molded product and the environmental cleaning material. That is, since the chlorine source contained in the carbonaceous material is NaCl, chlorine can be removed simply by applying a water washing treatment to the carbonaceous material before mixing with the binder as described above. Since water used for the water washing treatment contains NaCl, it is desirably discharged into sea after removing SS (suspended solids) or COD (chemical oxygen demand).

### EXAMPLE

Molded products were produced in the production steps shown in FIG. 1 and FIG. 3 under the following conditions. Cement was used as the binder and Table 2 shows the result of investigation for the nature and the composition of the thus obtained molded product. Then, Table 3 shows the result of an investigation test of using the molded product as it is as the environment cleaning material and investigating the result of a leaching test for various environments.

[Dry Distillation Step]

Oxygen concentration in furnace:1 vol % or less

Temperature of carbonaceous material: 600° C.

[Binder Mixing Step]

30 mass % of cement and 20 mass % of water were added to the carbonaceous material (100 mass %) and mixed and pelleted.

A molded product with 23 mass % of binder content was obtained.

As a result of conducting an exposure test to sea water on the purifying performance of the molded product, as shown in FIG. 4, growing of algae was better and deposition of shellfishes was favorable compared with usual algae growing concretes. That is, growth of animals and plants means excellent growing circumstance and also shows the presence of water purifying effect.

Further, when the same material as the carbonaceous material used for preparation of the molded product is mixed with cement as a binder, iron sand was mixed as the iron source and a high specific gravity molded product was also prepared under the following binder mixing condition. The specific gravity was controlled to a bulk specific gravity of 1.4 to 1.6 conforming the average bulk specific gravity of sands on coastal lines of 1.4 to 1.6 (true specific gravity 2.4-2.6). Table 5 shows the nature and the composition of the obtained molded product. The thus obtained molded product of an average particle diameter of 5 mm was served as it was as the environmental cleaning material for the scattering test on the sea shore. After lapse of 3 months, when localization of the environment cleaning material in the area scattered with the environment cleaning material was investigated, scarce change was observed for the flushing loss due to waves or in the mixing amount in deposits.

[Binder Mixing Step: Molded Product at High Specific Gravity]

30 mass % of cement and 20 mass % of water were added to a mixture of 57 mass % of carbonaceous material and 43 mass % of iron sand and mixed and pelleted.

A molded product with a binder content of 23 mass % was obtained.

TABLE 1

| | | | | | | NA + | | | Oth- |
|---|---|---|---|---|---|---|---|---|---|
| C | SiO₂ | Al₂O₃ | CaO | MgO | S | K | Zn | Cl | ers |
| 52.6 | 15.2 | 8.7 | 9.4 | 1.3 | 0.17 | 2.75 | 0.11 | 2.77 | 7.0 |

TABLE 2

| | | Solid | | Environment |
|---|---|---|---|---|
| | | refuse | Carbonaceous | cleaning |
| | | fuel | powder | material |
| Bulk specific | | 0.59 | 0.45 | 1.2 |
| gravity (g/cm³) | | | | |
| Water | | 3.5 | 5.3 | 10.5 |
| content (%) | | | | |
| Ash (%) | | 10.3 | 39.8 | 20.0 |
| Combustible | | 85.2 | 54.9 | 22.0 |
| component (%) | | | | |
| Volatile component (%) | | 75.6 | 12.5 | 6.0 |
| Compositional | C | 50.5 | 45.2 | 22.0 |
| ingredient | (mass %) | | | |
| | H | 7.8 | 1.1 | 0.1 |
| | (mass %) | | | |
| | N | 0.8 | 1.0 | 0.5 |
| | (mass %) | | | |
| | S | 0.11 | 0.096 | 0.005 |
| | (mass %) | | | |

TABLE 3

| | Measured | Measured | Standard | Standard | Standard |
|---|---|---|---|---|---|
| | item | value | 1 (*) | 2 (*) | 3 (*) |
| Deleteri- | Total | <0.0001 | 0.005 | 0.005 | 0.0005 |
| ous | mercury | | | | |
| material | (mg/l) | | | | |
| | Cadmium | <0.01 | 0.1 | 0.03 | 0.01 |
| | (mg/l) | | | | |
| | Lead | <0.01 | 0.1 | 0.2 | 0.01 |
| | (mg/l) | | | | |
| Living | Zinc | 0.04 | 5.0 | — | — |
| environ- | (mg/l) | | | | |
| ment | Phosphorus | 0.41 | 8.0 | — | — |
| item | (mg/l) | | | | |
| | Chromium | <0.01 | 2.0 | — | — |
| | (mg/l) | | | | |
| | Copper | <0.01 | 3.0 | — | — |
| | (mg/l) | | | | |

(*) Standard 1: Effluent standard value according to Water Pollution Control Law
Standard 2: Land fill standard value according to Water Pollution Control Law
Standard 3: Soil contamination environment standard value according to Water Pollution Control Law

TABLE 4

| | Product only | Environment |
|---|---|---|
| | composed of | cleaning |
| | concrete | material |
| | (Comparative | (Example of |
| | example) | the invention) |
| Amount of algae formed | 1 | 3-4 |
| on unit weight (index) | | |
| Deposition rate of | 1 | 3-4 |
| shellfishes per unit | | |
| weight (index) | | |

TABLE 5

| | | Environment |
|---|---|---|
| | | cleaning |
| | | material |
| Bulk specific gravity (g/cm³) | | 1.45 |
| Water content (%) | | 8.5 |
| Ash (%) | | 26.0 |
| Combustible component (%) | | 15.0 |
| Volatile component (%) | | 4.5 |
| Compositional | C | 18.5 |
| ingredient | (mass %) | |
| | H | 0.07 |
| | (mass %) | |
| | N | 0.4 |
| | (mass %) | |
| | S | 0.005 |
| | (mass %) | |

### INDUSTRIAL APPLICABILITY

According to this invention, since solidified refuse fuels are formed into a molded product which is utilized, for example, as an environment cleaning material, it is possible to promote consumption of solidified refuse fuels to promote environment preserving refuse disposal and also improve the environment.

1. A molded product comprising a carbonaceous material having a carbon content of 30 to 70 mass % obtained by dry distillation of solidified refuse fuels and a binder.

2. A molded product as defined in claim 1 containing 5 to 90 mass % of the binder.

3. A molded product as defined in claim 2, wherein the binder is at least one material selected from the group consisting of cement, gypsum, clay and soil hardening agent.

4. A molded product as defined in claim 1, wherein the particle diameter is 0.5 to 50.0 mm.

5. An environment cleaning material using the molded product as defined in claims 1-4.

6. A molded product as defined in claim 1 to 4, which is further mixed with at least one material selected from the group consisting of iron and iron compounds.

7. A molded product as defined in claim 6, wherein the iron compound is at least one material selected from the group consisting of iron oxides, iron hydroxides, iron ores and iron sands.

8. A molded product as defined in claim 6, having a bulk specific gravity of 1.2 to 2.0.

9. An environment cleaning material using the molded product as defined in claim 6.

10. A method of manufacturing a molded product which comprises dry distilling solidified refuse fuels to obtain a carbonaceous material having a carbon content of 30 to 70 mass %, mixing a binder with the carbonaceous material, molding and then drying them.

11. A method of manufacturing a molded product as defined in claim 10, wherein at least one material selected from the group consisting of iron and iron compounds is further mixed upon mixing the binder.

12. A method of manufacturing a molded product as defined in claim 10 or 11, wherein the carbonaceous material is used after water washing.
